(19) United States
(12) Patent Application Publication
(10) Pub. No.: US 2026/0208695 A1
(43) Pub. Date: Jul. 23, 2026

(54) METHOD FOR OPERATING A VEHICLE FUNCTION OF A MOTOR VEHICLE, MOTOR VEHICLE, AND ELECTRONIC DEVICE

(71) Applicant: VOLKSWAGEN AKTIENGESELLSCHAFT, Wolfsburg (DE)

(72) Inventor: Bernd Ette, Wolfsburg (DE)

(21) Appl. No.: 19/138,559

(22) PCT Filed: Dec. 11, 2023
(86) PCT No.: PCT/EP2023/085027

§ 371 Date: Jun. 12, 2025

(30) Foreign Application Priority Data
Dec. 19, 2022 (DE) 10 2022 213 946.1

(51) Int. Cl. B60R 25/24; G07C 9/00

(52) U.S. Cl. CPC B60R 25/245; G07C 9/00309; G07C 2209/63

(57) ABSTRACT

Methods and systems for operating a vehicle function of a motor vehicle are disclosed. A path and an orientation of a user are determined using a positioning method based on ultra-wideband (UWB) measurements in combination with sensor data from an inertial measurement unit of an electronic device. One or more vehicle functions are performed based on the determined path and orientation of the user. This enables intuitive operation of the vehicle without requiring predefined gestures or direct actuation by the user.

### RELATED APPLICATIONS

The present application claims priority to International Patent Application No. PCT/EP2023/085027 to Bernd Ette, filed Dec. 11, 2023, which claims priority from German Patent App. No. DE 10 2022 213 946.1, filed Dec. 19, 2022, the contents of each being incorporated by reference in their entirety herein.

### TECHNICAL FIELD

The invention relates to two methods for operating a vehicle function of a motor vehicle, to a motor vehicle, and to an electronic device.

### BACKGROUND

Various solutions are known in the prior art for operating vehicle functions, such as opening a tailgate, unlocking or locking a central locking system, and similar tasks.

Many of these solutions are based on capacitive sensor systems, which are installed at the doors and hatches of the vehicle in the form of touch surfaces or buttons. The desired vehicle function is triggered when a user touches these surfaces, such as opening or closing the tailgate or sliding door, as described in document WO 2021/156188 A1.

However, a disadvantage of solutions that utilize capacitive sensor systems is that the user always needs a free hand to touch the surface in order to operate the vehicle function. When a user approaches their vehicle, they do not want to depend on having their hands free each time to perform a function. Often, the user is carrying items that they intend to stow in the vehicle.

For this reason, some vehicle manufacturers have begun equipping vehicles with kick sensor systems that detect movement made with a foot or leg. Such a solution is illustrated in document DE 10 2020 209 357 A1. This allows the user to operate a vehicle function, such as opening the tailgate, with a kick movement, typically by guiding the foot along a sensor located in the lower region of the vehicle.

However, it is not intuitive for users to operate a vehicle function with a kick movement, as this does not align with the natural sequence of a person's movements. Therefore, it is desirable to provide an operating option for a vehicle function that can be performed without an additional action, such as a hand or leg movement.

Document DE 10 2012 212 260 A1 relates to a method and device for controlling the operation of a fully automatic driver assistance system designed for independent vehicle guidance, particularly for parking.

Document DE 10 2020 112 198 A1 discloses a system and a method for easily and flexibly controlling vehicle functions.

Document DE 10 2019 211 192 A1 relates to a system and method for determining whether an ID transmitter is located in the passenger compartment of a vehicle.

Document DE 10 2013 225 600 A1 describes a vehicle system and a method for determining the current position of a wireless device on a vehicle based on a previously detected position.

Document DE 10 2018 222 761 A1 describes a method for authenticating a vehicle user using movement data from a mobile electronic identification transmitter.

### SUMMARY

Accordingly, aspects of the present disclosure are directed to providing simplified technologies and techniques for operating a vehicle function of a motor vehicle.

Some aspects are achieved by various methods for operating a vehicle function of a motor vehicle, by a motor vehicle, and by an electronic device as described in the independent claims. Other aspects are disclosed in the subject matter of the respective dependent subclaims.

In some aspects, a method is disclosed for operating a vehicle function of a motor vehicle. The motor vehicle comprises a radio system that includes a transceiver, a first ultra-wideband (UWB) antenna, and a second UWB antenna. The transceiver of the radio system is designed to transmit and receive signals across very large frequency ranges, specifically in a range of 3.1 GHz to 10.6 GHz, preferably from 3.5 GHz to 9 GHz, and particularly preferably from 6 GHz to 8.5 GHz. The transmission power of the UWB pulses is low. The bandwidth of the UWB signal is at least 500 MHz, and the UWB transceiver is preferably designed to transmit signals with a transmission power between 0.5 mW and −41.3 dBm/MHz. Furthermore, the transceiver is preferably designed according to the IEEE 802.15.4 standard (particularly the sections on the UWB PHY layer) and according to the IEEE 802.15.4z standard. By spreading the signals across such large frequency ranges, UWB signals interfere minimally with other radio signals.

In some examples, a motor vehicle is disclosed, comprising a radio system including a transceiver, a first UWB antenna, a second UWB antenna, and a control device. The control device is configured to carry out the method described herein. The features and advantages described with the method can be analogously implemented with the motor vehicle and can therefore be freely combined with one another.

In some examples, a method is disclosed for operating a vehicle function of a motor vehicle comprising a radio system including a transceiver, a first UWB antenna, and a second UWB antenna. The motor vehicle is preferably the one described above. The vehicle function includes activating a central locking system to lock or unlock the motor vehicle, activating an actuator to open a door, hatch, and/or window of the motor vehicle, and/or activating a lighting system of the motor vehicle.

According to a first step, a second radio system of a user's electronic device is activated to respond to a positioning method based on time-of-flight measurements carried out by the radio system of the motor vehicle, determining the position of the second radio system relative to the motor vehicle. The electronic device is preferably the one described herein. Furthermore, user data are transmitted to the radio system using the second radio system. The user data include sensor data from an inertial measuring unit of the electronic device or an orientation of the user determined by the electronic device from the sensor data. Additionally, a vehicle function of the motor vehicle is operated based on a walking route and the user's orientation with respect to the motor vehicle. The features and advantages described with the method and the motor vehicle can be analogously implemented with the further method and can therefore be freely combined with one another.

In some examples, an electronic device is disclosed, the electronic device being configured to operate a vehicle function of a motor vehicle. The motor vehicle includes a radio system comprising a transceiver, a first UWB antenna, and a second UWB antenna. The motor vehicle is preferably the one described herein. The electronic device comprises a second radio system and a control unit configured to carry out the further method described herein. The features and advantages described with the further method can be analogously implemented with the electronic device and can therefore be freely combined with one another. The electronic device and the motor vehicle described herein preferably form a system for operating a vehicle function of the motor vehicle.

The above-described control device of the motor vehicle and/or the above-described control unit of the electronic device are preferably implemented using electrical or electronic parts or components (hardware) or firmware (ASIC). Additionally, the functionality of the control device/control unit can be implemented during the execution of a suitable program (software). It is also preferred that the control device/control unit is implemented as a combination of hardware, firmware, and/or software. For example, individual components of the control device/control unit that provide specific functionalities may be designed as separate integrated circuits or arranged on a shared integrated circuit.

The individual components of the control device/control unit are preferably designed as one or more processes that run on one or more processors in one or more electronic processing devices and are generated during execution by one or more computer programs. The processing devices are preferably designed to cooperate with other components, such as a central locking system, a motor controller, and the like, to implement the functionalities described herein. The instructions of the computer programs are preferably stored in a memory, such as a RAM element. However, the computer programs can also be stored in a non-volatile memory medium, such as a CD-ROM, Flash memory, or the like.

It is also evident to a person skilled in the art that the functionalities of multiple processing units (data processing devices) can be combined into a single device or that the functionality of a certain data processing device can be distributed among multiple devices to implement the functionality of the control device/control unit.

In some examples, a computer program is disclosed including commands that, when the program is being executed by a computer, such as a control device of a motor vehicle comprising a radio system that includes a transceiver with a first UWB antenna and a second UWB antenna, or a control unit of an electronic device, prompt the computer to carry out one of the methods according to the invention, particularly a method for operating a vehicle function of a motor vehicle.

Further preferred embodiments of the invention are derived from the remaining features described in the dependent claims.

The various embodiments of the present disclosure described in the present application can advantageously be combined with one another unless indicated otherwise in a specific instance.

### BRIEF DESCRIPTION OF THE DRAWINGS

Aspects of the present disclosed are described hereafter in exemplary embodiments based on the associated drawings. In the drawings:

FIG. 1 shows a schematic representation of a motor vehicle and an electronic device according to some aspects of the present disclosure;

FIG. 2 shows a schematic representation of a method according to some aspects of the present disclosure; and

FIG. 3 shows a schematic representation of a further method according to some aspects of the present disclosure.

### DETAILED DESCRIPTION

In some examples disclosed herein, a method includes activating a radio system to carry out a positioning process based on time-of-flight measurements to determine the position of a second radio system associated with a user's electronic device. The present disclosure is based on the assumption that the detected position of the electronic device corresponds to the position of the user. Accordingly, the position of the electronic device is considered synonymous with the position of the user. The activation of the radio system may include activating a first UWB antenna at a first time t1 to transmit a UWB pulse to the second radio system and at a second time t2 to receive a UWB pulse from the second radio system. A total time of flight may be determined based on the transmission and reception times and a processing delay ΔTVB at the second radio system. A distance between the radio system and the second radio system is then calculated using the total time of flight and the speed of light.

In a subsequent step, user data are received from the second radio system via the radio system. In other words, a UWB radio transmission is established with the second radio system. The UWB antennas may be alternately activated for time-of-flight-based positioning and radio data transmission. In some examples, the UWB pulses used for positioning may also contain user data.

The user data may include sensor information from an inertial measurement unit (IMU) of the electronic device or orientation data derived therefrom. The IMU may include one or more acceleration sensors, rotation rate sensors, and/or gyroscopes. Accordingly, the sensor data may include acceleration values and/or angular speed values from which the orientation of the user can be determined. In other words, the user's orientation may be derived from the orientation of the electronic device. The orientation with respect to the vehicle may be described as a rotational position of the user about the vehicle's z-axis (yaw axis).

A walking path and the orientation of the user with respect to the motor vehicle are determined based on the results of the positioning method and the received user data. To determine an initial orientation, the system may wait until a positional change exceeds a movement radius of at least 1.5 meters from the initially detected position. In other words, a vector extending from the initial position to the first detected position outside a 1.5-meter radius is used to define the user's initial orientation.

By tracking the user's position over time, a trajectory may be reconstructed, and the orientation of the user along the trajectory may be calculated using the received sensor data. The combination of position data and user data enables the identification and prevention of misuse cases. For instance, if the user removes the electronic device, such as a mobile terminal or smartphone, from a pocket, this is recognized based on IMU sensor data showing not only rotation about the z-axis but also significant rotational movements along the x- and/or y-axes (i.e., roll and/or pitch). The system may also distinguish between walking forward, sideways, or backward based on characteristic rotational patterns of the user's natural gait.

In a further step, a vehicle function is initiated based on the determined walking path and user orientation relative to the vehicle. The vehicle function may include activation of the central locking system, actuation of a door, hatch, or window, activation of the lighting system, and the like. The present disclosure enables intuitive interaction with the vehicle by recognizing natural user movements, eliminating the need for predefined gestures such as touching capacitive sensors or performing deliberate foot motions.

For example, when the user approaches the motor vehicle, moves toward the tailgate, and aligns their body with the tailgate, this behavior may be recognized and result in the automatic opening of the tailgate. This allows the user to stow items without performing a specific activation gesture. As a result, additional sensor systems may be omitted. The present disclosure also enables precise selection of sub-regions on the vehicle for triggering functions. These sub-regions may be resolved with dimensions of 0.5 m×0.5 m and an angular resolution of ±5 degrees.

To differentiate between intentional and unintentional activations, the system may detect when the user simply passes by the vehicle and prevent unintended operation.

In some examples, the vehicle function is performed only if the walking path indicates that the user is located within a predefined region associated with the function and/or is oriented toward the vehicle. The predefined regions may include areas in front of the hood, tailgate, doors, or fuel tank cap, depending on the function to be triggered.

The user may be considered to face the vehicle when their orientation deviates no more than ±45 degrees, preferably ±30 degrees, and particularly preferably ±15 degrees from a frontal alignment with the vehicle. This tolerance enables intuitive operation while reducing the likelihood of false activations.

Additionally or alternatively, the vehicle function may be performed if the user remains within the predefined region for a specified duration and/or if the walking path exceeds a predefined length. The duration may range from 100 ms to 1000 ms, preferably from 200 ms to 600 ms, and particularly around 400 ms. The path length may range from 0.5 m to 5 m, preferably 1 m to 3 m, and particularly around 1.5 m. These thresholds help distinguish deliberate user behavior from incidental movement.

In addition or as an alternative, the radio system for transmitting and receiving UWB pulses may be activated using at least one of the UWB antennas when the user is located within the functional region and/or is oriented toward the vehicle. Due to the high temporal resolution of UWB pulses, information about the propagation path can be extracted from received pulse responses.

Environmental influences, such as refraction, diffraction, reflection, or attenuation, can cause deviations from the geometric path of the pulses. Differences in time of flight and pulse shape—caused by the presence or absence of nearby objects—can be used to infer the presence or absence of such objects or users along the propagation path.

In some examples, the vehicle function is triggered based on gesture detection derived from received pulse responses. Gesture recognition may be based on the user's detected position relative to the nearest UWB antenna. This mechanism may be employed to further reduce misuse, particularly in cases where trajectory and orientation data produce ambiguous results.

If ambiguity is detected, the vehicle function may be executed only when a corresponding gesture is recognized. Known gesture patterns from prior art may be used for this purpose; a detailed description is omitted for brevity.

In another example, the user may be authenticated using authentication data transmitted from the second radio system and received by the radio system. At least one method step may be contingent on successful authentication. Authentication may occur prior to the positioning process, allowing the system to conserve computational resources when access is denied.

Authentication also supports a fundamental safety principle, whereby vehicle operations are limited to authenticated users.

The radio system and the second radio system may each include a Bluetooth (BT) antenna configured to transmit and receive Bluetooth signals, particularly Bluetooth Low Energy (BLE). Authentication data may be received using the BT antenna of the radio system.

Since BT has a longer range than UWB, the user may be authenticated before UWB-based positioning begins.

In another example, the walking path and/or user orientation may be determined using a digital filter, such as a Kalman filter, applied to the received sensor data. This improves the precision of the movement and orientation estimations.

In a further example, the vehicle function may be executed based on the user's path and orientation only if the user is located within a maximum distance of 10 meters, and preferably within 5 meters, from the vehicle. Detection beyond 10 meters may be unreliable due to increased measurement error. Within 5 meters, the detection is especially reliable. This constraint saves computing capacity and ensures accurate interaction with the vehicle.

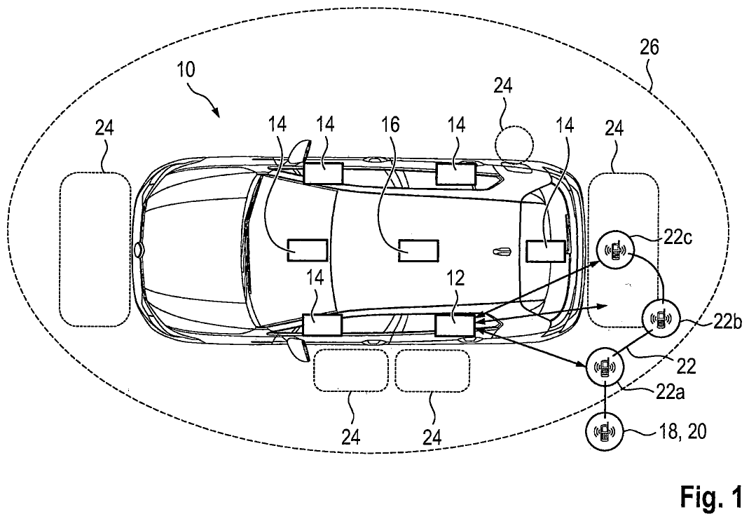

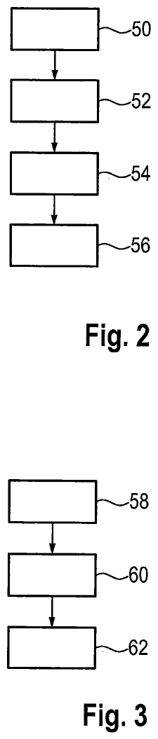

FIG. 1 shows a schematic representation of a motor vehicle 10 and an electronic device 18 according to one specific embodiment. The motor vehicle 10 comprises a radio system that includes a transceiver and six UWB antennas 12, 14, along with a control device 16 connected to the radio system. The control device 16 is specifically equipped to carry out a method for operating a vehicle function of the motor vehicle 10, which is described in connection with FIG. 2. Five of the six UWB antennas 12, 14 are distributed among the five doors of the motor vehicle 10, while the sixth UWB antenna 14 is positioned near the interior rear-view mirror of the motor vehicle 10. More precisely, the first UWB antenna 12 is located in the door behind the driver's door, the second UWB antenna 14 is situated in the driver's door, the third UWB antenna 14 is positioned in the tailgate, the fourth UWB antenna 14 is located in the door behind the front seat passenger's door, and the fifth UWB antenna 14 is in the front seat passenger's door. The number and arrangement of the UWB antennas 12, 14 are provided only as examples to enhance understanding. The disclosure is therefore not limited to the shown arrangement and number of UWB antennas 12, 14. Furthermore, it is possible to utilize UWB antennas that are already installed in the motor vehicle 10. Some modern vehicles include UWB antennas that are installed for the purpose of keyless access. As a result, multifunctional use of the UWB antennas 12, 14 is possible, leading to cost savings.

The electronic device 18 is configured to operate a vehicle function of the motor vehicle 10. The electronic device 18 is a mobile terminal, specifically a smartphone, of a user 20. The electronic device 18 includes a second radio system with a second transceiver that has at least one UWB antenna configured to transmit and receive UWB pulses. Additionally, the electronic device 18 contains a control unit, which is specifically designed to carry out a method for operating a vehicle function of the motor vehicle 10, as illustrated in connection with FIG. 3. The electronic device 18 also comprises an inertial measuring unit, which includes a gyroscope and acceleration sensors that generate sensor data encompassing angular velocities and accelerations of the electronic device 18. The control unit of the electronic device 18 is preferably configured to ascertain the orientation of the user 20 based on the sensor data from the inertial measuring unit.

The control device 16 of the motor vehicle 10 is configured to activate the radio system for a positioning method based on time-of-flight measurements, which determines the position of the second radio system of the electronic device 18 of the user 20 and receives user data from the second radio system. The position of the user 20 and the position of the electronic device 18 are considered synonymous herein. The user data includes the sensor data from the inertial measuring unit of the electronic device 18. The control device 16 is also configured to ascertain a walking route 22 and the orientation of the user 20 with respect to the motor vehicle 10 based on the results of the positioning method and the received user data, and to perform a vehicle function based on the ascertained walking route 22 and the orientation of the user 20 with respect to the motor vehicle 10.

As shown by way of example in FIG. 1, predefined regions 24 are established in the vehicle surroundings of the motor vehicle 10, which are linked to operable vehicle functions. These predefined regions 24 are indicated with dotted lines. For example, a predefined region 24 is located in front of the hood and behind the tailgate for operating the hood or the tailgate. Each of the four vehicle doors of the motor vehicle 10 also has a respective predefined region 24 assigned to it. For clarity, only the predefined regions 24 on the left side of the motor vehicle are shown in FIG. 1; analogous regions are, of course, provided for the right side as well. A further predefined region 24 is located at the height of the fuel door of the motor vehicle 10. By entering one of the predefined regions 24, a user 20 can operate the vehicle functions associated with that region. For instance, the hood and the tailgate can be opened when the user enters the respective predefined region 24 and can preferably be closed again when the user leaves it. Regarding the predefined regions 24 of the vehicle doors, locking or unlocking of the central locking system of the motor vehicle 10 can be activated, while opening or closing of the fuel door can occur when the predefined region 24 of the fuel door is entered or exited.

To reduce the occurrence of undesired misuse by the user 20, the user's position is determined multiple times, particularly as often as necessary, using the time-of-flight measurement method. However, the position is only determined once the user 20 enters a periphery 26 of 10 m around the motor vehicle 10. The periphery 26 is illustrated, for example, with a dotted ellipse in FIG. 1, surrounding the motor vehicle 10. When the user 20 enters the periphery 26, his or her position is continuously ascertained (in a periodically recurring manner), and the sensor data are also received continuously (in a periodically recurring manner) from the electronic device 18. The walking route 22 (trajectory) of the user 20 is then determined from the ascertained positions and the received sensor data.

To provide a better understanding of the invention, an exemplary walking route 22 of the user 20 to the tailgate of the motor vehicle 10 is illustrated. The invention is, of course, not limited to this particular walking route 22; rather, a plurality of walking routes 22, in particular routes toward or away from other predefined regions 24, can be ascertained. According to the walking route 22 shown in FIG. 1, the user 20 is initially located outside the periphery 26 of the motor vehicle 10 and then moves toward the vehicle, specifically toward the tailgate. As soon as the user 20 has entered the periphery 26, indicated at point 22a of the walking route 22, their position is determined using a time-of-flight measurement method with the UWB antennas 12 and 14. Additionally, the current sensor data from the electronic device 18 are received. This is shown by the arrow between the first UWB antenna 12 and point 22a. To ascertain the user's position concerning the motor vehicle 10, at least one second UWB antenna 14 must perform the time-of-flight measurement to enable position finding (triangulation) at point 22a. For clarity, no arrow is shown for this in FIG. 1. Preferably, all UWB antennas 12 and 14 are activated to achieve the most accurate position determination of the user 20 possible.

If no orientation of the user 20 is transmitted by the electronic device 18, but only the sensor data from the inertial measuring unit, a vector from the first position of the user 20 (point 22a) to a second position of the user 20 (point 22b), which is ascertained later, is assumed as the initial orientation of the user 20. At point 22b on the walking route 22, the user is already partially situated in the predefined region 24 for the tailgate. To prevent misuse of the vehicle function, the invention considers not only the walking route 22 of the user 20 but also their orientation. Based on the initial orientation and the received sensor data, the orientation of the user 20 can be continually estimated and updated. Only when the user 20, such as at point 22c of the walking route 22, is oriented toward the tailgate of the motor vehicle 10 and is also located in the predefined region 24 is the tailgate of the motor vehicle 10 opened automatically. More precisely, the control device 16 then transmits a control signal to the actuator of the tailgate to open it. At point 22b, the user's orientation is substantially orthogonal to the tailgate, meaning they do not face it. As a result, the tailgate is not opened even though the user 20 is partially situated in the predefined region 24. At this point 22b, however, it is not yet clear or predictable whether the user 20 is indeed walking toward the tailgate or if they might simply pass by the motor vehicle 10 or even intend to walk toward another predefined region 24, for example, to open the fuel door.

FIG. 2 shows a schematic representation of a method according to one embodiment for carrying out the process. The control device 16 of the motor vehicle 10 is specifically configured to implement this method.

In a first step 50, the radio system is activated to perform the time-of-flight measurement-based positioning method for determining the position of the second radio system of the electronic device 18 used by the user 20.

In a second step 52, user data are received from the second radio system via the radio system of the motor vehicle 10. The user data include sensor data from the inertial measuring unit of the electronic device 18.

Based on the results of the positioning method and the received user data, a walking route 22 and the orientation of the user 20 in relation to the motor vehicle 10 are determined in a third step 54.

In a fourth step 56, a vehicle function is performed based on the determined walking route 22 and the orientation of the user 20 with respect to the motor vehicle 10.

FIG. 3 shows a schematic representation of a further method according to one embodiment for carrying out the method. The control unit of the electronic device 18 is specifically configured to execute this method.

In the first method step 58 of the further method, the second radio system of the electronic device 18 of the user 20 is activated to respond to a positioning method based on time-of-flight measurements conducted by the radio system of the motor vehicle 10, determining the position of the second radio system relative to the motor vehicle 10.

In the second method step 60 of the further method, user data are transmitted to the radio system of the motor vehicle 10 via the second radio system, where the user data include sensor data from the inertial measuring unit of the electronic device 18.

According to a third method step 62 of the further method, a vehicle function of the motor vehicle 10 is operated based on a walking route and the orientation of the user 20 relative to the motor vehicle 10. In other words, the user 20 operates the vehicle function using the selected walking route and the chosen orientation with respect to the motor vehicle 10, particularly at the end of the walking route.

### LIST OF REFERENCE NUMERALS

10 motor vehicle
12 first UWB antenna
14 second UWB antenna
16 control device
18 electronic device
20 user
22 walking route
22a, 22b, 22c points on the walking route
24 predefined region
26 periphery
50 first method step
52 second method step
54 third method step
56 fourth method step
58 first method step of a further method
60 second method step of the further method
62 third method step of the further method

1-10. (canceled)

11. A method for operating a vehicle function of a motor vehicle, the motor vehicle comprising a radio system including a transceiver, a first ultra-wideband (UWB) antenna, and a second UWB antenna, the method comprising:
activating the radio system to perform a positioning method based on time-of-flight measurements to determine a position of a second radio system of an electronic device associated with a user;
receiving user data from the second radio system, wherein the user data comprise sensor data from an inertial measurement unit of the electronic device or an orientation of the user determined therefrom;
ascertaining a walking route and an orientation of the user with respect to the motor vehicle based on the determined position and the received user data; and
carrying out a vehicle function based on the ascertained walking route and the orientation of the user with respect to the motor vehicle.

12. The method of claim 11, wherein the vehicle function comprises activating a central locking system to lock or unlock the motor vehicle, activating an actuator to open a door, a hatch, or a window of the motor vehicle, or activating a lighting system of the motor vehicle.

13. The method of claim 11, wherein the vehicle function is carried out when the walking route indicates that the user has reached or is located in a predefined region for the vehicle function, or when the orientation of the user indicates that the user is facing the motor vehicle.

14. The method of claim 13, wherein the vehicle function is further carried out when the user remains in the predefined region for at least a predefined waiting period or when the walking route exceeds a predefined length.

15. The method of claim 11, wherein the radio system is activated to transmit UWB pulses and receive pulse responses using at least one of the UWB antennas when the user is located in the predefined region or is facing the motor vehicle, and the vehicle function is carried out based on recognition of a gesture movement of the user from the received pulse responses.

16. The method of claim 11, further comprising authenticating the user based on authentication data received from the second radio system, wherein at least one step of the method is performed in response to successful authentication.

17. The method of claim 11, wherein the walking route or orientation of the user is determined using a digital filter.

18. The method of claim 11, wherein the vehicle function is carried out only if the user is located within a maximum periphery of 10 meters around the motor vehicle.

19. A method for operating a vehicle function of a motor vehicle, the motor vehicle comprising a radio system including a transceiver, a first ultra-wideband (UWB) antenna, and a second UWB antenna, the method comprising:
activating a second radio system of an electronic device associated with a user to respond to a positioning method performed by the radio system of the motor vehicle, the positioning method being based on time-of-flight measurements to determine a position of the second radio system with respect to the motor vehicle;
receiving, at the radio system, user data transmitted from the second radio system, wherein the user data comprise sensor data from an inertial measurement unit of the electronic device or an orientation of the user determined based on the sensor data; and
operating a vehicle function of the motor vehicle based on a walking route and an orientation of the user with respect to the motor vehicle, the walking route and the orientation being determined based on the time-of-flight measurements and the received user data.

20. The method of claim 19, wherein the vehicle function comprises activating a central locking system to lock or unlock the motor vehicle, activating an actuator to open a door, a hatch, or a window of the motor vehicle, or activating a lighting system of the motor vehicle.

21. The method of claim 19, wherein the vehicle function is carried out when the walking route indicates that the user is located in a predefined region associated with the vehicle function or when the orientation of the user indicates that the user is facing the motor vehicle.

22. The method of claim 21, wherein the vehicle function is further carried out when the user remains in the predefined region for at least a predefined waiting period or when the walking route exceeds a predefined length.

23. The method of claim 19, further comprising activating the radio system to transmit UWB pulses and receive pulse responses using at least one of the UWB antennas when the user is located in the predefined region or is facing the motor vehicle, and operating the vehicle function based on a recognition of a gesture movement of the user determined from the received pulse responses.

24. The method of claim 19, further comprising authenticating the user based on authentication data received from the second radio system, wherein at least one of the method steps is performed in response to successful authentication.

25. The method of claim 19, wherein the walking route or the orientation of the user is determined using a digital filter.

26. An electronic device for operating a vehicle function of a motor vehicle, the motor vehicle comprising a radio system including a transceiver, a first ultra-wideband (UWB) antenna, and a second UWB antenna, the electronic device comprising:
a second radio system; and
a control unit configured to:
(i) respond to activation of the radio system by enabling participation in a positioning procedure based on time-of-flight measurements for determining a position of the electronic device with respect to the motor vehicle;
(ii) transmit user data to the radio system, wherein the user data comprise sensor data from an inertial measurement unit of the electronic device or an orientation of a user determined therefrom; and
(iii) enable the vehicle function to be carried out based on a walking route and an orientation of the user with respect to the motor vehicle, wherein the walking route and the orientation are determined using the position and the user data.

27. The electronic device of claim 26, wherein the control unit is further configured to enable the vehicle function when the walking route indicates that the user is located in a predefined region associated with the vehicle function, or when the orientation of the user indicates that the user is facing the motor vehicle.

28. The electronic device of claim 26, wherein the inertial measurement unit comprises at least one of an accelerometer, a gyroscope, and a rotation rate sensor, and the control unit is configured to determine an orientation of the user relative to the motor vehicle based on sensor data from the inertial measurement unit.

29. The electronic device of claim 26, wherein the control unit is configured to transmit authentication data to the radio system for authenticating the user before participating in the positioning operation to determine the position of the electronic device relative to the motor vehicle.

30. The electronic device of claim 26, wherein the control unit is further configured to apply a digital filter to the sensor data to improve accuracy of the determined walking route and orientation.
